(19) United States
(12) Patent Application Publication
(10) Pub. No.: US 2026/0363479 A1
(43) Pub. Date: Nov. 19, 2026

(54) MIXING DEVICE FOR BEVERAGE PREPARATION

(71) Applicant: SOCIÉTÉ DES PRODUITS NESTLÉ S.A., Vevey (CH)

(72) Inventors: Gareth ELLIOTT, Yverdon-Les-bains (CH); Mia DUBEI, Epalinges (CH); Timothée REGNIER, Métabief (FR); Sylvie RAMQAJ, Longevilles Mont d’Or (FR)

(21) Appl. No.: 19/148,112

(22) PCT Filed: Jan. 10, 2024
(86) PCT No.: PCT/EP2024/050437

§ 371 Date: Jul. 15, 2025

(30) Foreign Application Priority Data
Jan. 16, 2023 (EP) 23151719.4

(51) Int. Cl. A47J 31/40; B01F 27/115; B01F 27/73; B01F 101/14

(52) U.S. Cl. CPC A47J 31/401; B01F 27/115; B01F 27/73; B01F 2101/14

(57) ABSTRACT

The invention concerns a mixing device (1) comprising: —a whipper housing (2), a whipper (3) and a back wall (4), —a drive shaft (81) for driving the whipper, —the whipper housing comprising a front wall (21), said front wall facing the radial front surface (32) of the whipper, and wherein said whipper (3) is disc shaped, and wherein at least a part of the surface of the radial front surface (32) of the whipper is rough and presents an arithmetic maximum surface roughness (Sz) of at least 200 μm.

### FIELD OF THE INVENTION

The present invention relates to a plant-based milk and its use in its use in coffee beverages.

### BACKGROUND OF THE INVENTION

Many frothy beverages like milk beverages, chocolate beverages, . . . are often prepared by mixing a food soluble powder or a food liquid concentrate with a diluent. Mixing devices are known for speedier preparation of such beverages by mixing the soluble food component with the diluent, such as water. These devices typically comprise a mixing chamber in which the soluble component and the diluent are fed. The diluent can be introduced into the dissolution chamber in order to create a whirlpool to efficiently dissolve the soluble component in the hot water or the hot diluent can be introduced under the form of jets that provides mixing, dissolving and frothing. The mixture is then usually frothed by a whipper in a whipping chamber to reconstitute the beverage and produce foam. The beverage is then evacuated from the whipping chamber through the bottom of the chamber and dispensed into a receptacle for drinking.

In the prior art different types of whipping chambers have been developed for improving the quality of the foam of beverages. EP 1 476 060 and EP 1 639 924 describe similar whipping chambers in which the whippers present a tapered shape. Grooves or ribs are present on the whippers surfaces whereas the back wall of the whipping chamber can present protrusions or ribs. These whipping chambers were conceived for frothing various soluble powder ingredients; in particular these chambers were configured for frothing milk beverages as well as coffee beverages depending on the speed of actuation of the whipper. Consequently, these whipping chambers are not particularly optimized for the frothing of milk. Besides due to the presence of fine grooves on the whipper and ribs on the back wall these whipping chambers cannot be easily rapidly cleaned.

WO 2003/005868 describes a whipping chamber wherein the internal wall surface of the chamber comprises indentations. Due to these indentations cavitations are created when the whipper is activated. The whipper can also present breakers. This whipping chamber can be indifferently used for the preparation of lattes, cappuccinos or espressos and consequently this whipping chamber is not particularly optimized for the frothing of milk.

WO 2013/149942 describes a whipping chamber wherein the whipper housing front wall presents flat bumps with sharp edges elevating from the surface of the front wall. This whipping chamber enables the preparation of a high volume of dense milk foam from a milk powder and water.

Today there is an increasing demand of the customers for plant-based or non-dairy milks such as oat milk, almond milk, soy milk, coconut milk. These milks are hardly foamable and the use of above-described whipping chambers with powders of these plant-based milks do not enable the preparation of a high volume of dense milk foam. Yet, the properties of the milk foam are important in the preparation of specialty beverages based on milk and especially based on frothed milk like cappuccino, latte macchiato or cocoa based beverages. The properties of the milk foam of these beverages play an important role in the quality of the final beverage shall it concerns the visual aspect or the mouthfeel of the beverage.

But none of the whipper chambers of the prior art has been able to provide a real high quality foamed milk.

The object of the present invention is to propose a mixing device dedicated to the foaming of milk in order to provide a high quality plant-based milk foam for the preparation of frothed milk beverages.

It would be advantageous to provide a new mixing device that can be easily implemented in the current existing beverage dispensers, for example by replacing existing mixing devices with the new one.

### SUMMARY OF THE INVENTION

In a first aspect of the invention, there is provided a mixing device comprising:
a whipper housing, a whipper and a back wall, the whipper housing and the back wall forming a whipper chamber in which is lodged the whipper,
the whipper housing comprising a beverage inlet and a beverage outlet,
a drive shaft for driving the whipper, said drive shaft being supported by the back wall,
the whipper presenting a radial back surface facing the whipper housing back wall and a radial front surface opposed to the radial back surface
the whipper housing comprising a front wall, said front wall facing the radial front surface of the whipper, and
   wherein said whipper is disc shaped, and
   wherein at least a part of the surface of the radial front surface of the whipper is rough and presents an arithmetic maximum surface roughness (Sz) of at least 200 μm, preferably at least 400 μm.

The mixing device of the present invention comprises a whipper housing and a back wall configured for forming a whipper chamber when they are assembled together. The device also comprises a whipper or whipper for whipping the beverage to be prepared such as an impeller or a rotating disk. The whipper is driven by a driveshaft supported by the back wall of the whipper assembly. The whipper housing presents a front wall that faces the radial front surface of the whipper. The whipper housing comprises a beverage inlet through which the different components of the beverage are introduced for being whipped by the whipper. The beverage inlet is generally present in the front wall of the whipper housing. The front wall preferably presents the form of a truncated cone tapering from the beverage inlet to the peripheral edge of the front wall. The whipper housing also presents a peripheral side wall globally parallel to the drive shaft. This peripheral side wall globally presents the form of a cylinder. It surrounds the peripheral edge of the whipper. The whipper housing also comprises a beverage outlet through which the beverage whipped by the whipper is evacuated. A conduit or nozzle can be attached to the beverage outlet for dispensing in a drinking cup.

In the present invention:
the term “back” refers to the parts of the mixing device positioned near the back wall supporting the whipper drive shaft,
the term “front” refers to the parts of the mixing device positioned near the whipper housing beverage inlet,
the terms “radial” and “axial” are defined in relation to the axis of rotation of the whipper.

According to the invention, the whipper is disc shaped and the material surface of the radial front surface of the whipper is not smooth but rough. This roughness can be quantified by:
an arithmetic maximum surface roughness (Sz) at least 200 μm, preferably at least 400 μm, even more preferably comprised between 400 and 750 μm.
an arithmetic mean surface roughness (Sa) comprised of at least 30 μm, preferably at least 40 μm, even more preferably comprised between comprised between 40 and 100 μm.

This roughness increases the foaming a foamable beverages and in particular of hardly foamable beverage like plant-based milks.

In one preferred embodiment, the rough surface of the radial front surface of the whipper presents a pattern, preferably a geometric pattern, said pattern being engraved on the surface of the radial front surface of the whipper.

In this embodiment, the radial front surface combines a continuous rough surface and a pattern engraved in the rough surface. Usually, the design of the pattern results from lines engraved in the rough surface and presenting largest pit depth than the pit of the continuous rough surface.

Preferably, the front surface of the whipper comprises grooves radially extending on said surface.

Usually, these grooves are equally distanced one from the other.

Preferably these grooves extend from the centre of the disc to the periphery of the disc and present a depth comprised between 1 and 2 mm and a width comprised between 2 and 6 mm. Preferably, these grooves present a smooth surface contrary to the front surface of the whipper that extends between the grooves and that is rough.

Preferably, the whipper housing front wall presents bumps elevating from the surface of the front wall, the upper surface of each bump being flat and the edges of said upper surface being sharp. Such a whipper housing is similar to the housing described in WO 2013/149942. These bumps elevate from the whipper housing front wall surface that faces the front surface of the whipper. Then these bumps face the front surface of the whipper too. The upper surface of each bump—that is the most elevated part of the bump above the whipper housing front wall surface—is flat and the edges of said upper surface are sharp.

According to the preferred embodiment the beverage outlet is positioned at the lowest position of the whipper housing front wall.

Preferably the bumps are regularly radially disposed on the whipper housing front wall around the whipper central axis, except in the area of the beverage outlet. In particular it is preferred that the edges of both bumps surrounding the beverage outlet are positioned at more than 2 mm from the edge of the beverage outlet, preferably at more than 5 mm, even more preferably at a distance of 9 mm.

Preferably all the bumps present the same shape and the same size.

It is preferred that each bump extends along the whole radial length of the front wall. As the beverage inlet of the mixing device usually corresponds to an axial opening in the whipper housing front wall it means that the bumps can radially extend on the front wall surface from the front wall opening corresponding to the inlet of the mixing device up to the peripheral edge of the front wall.

Preferably the upper surface of each bump is parallel to the front wall surface. Each bump appears like a local elevation of the front wall surface.

Preferably for each bump, its width is greater than its height.

According to the preferred embodiment the bumps present the shape of a quadrilaterally-faced hexahedra solid, such as a trapezoidal solid, a cuboid or a cube. It has been noticed that such solids presenting a flat upper side, flat elevating faces and straight edges efficiently improved the formation of foam of quality. The bumps preferably present the shape of a cuboid that is a quadrilaterally-faced hexahedra solid composed of three pairs of rectangles.

The width and the number of bumps on the whipper housing front wall can vary. The sum of the surfaces of all the bumps is generally comprised between 20 and 75% of the whipper housing front wall surface, preferably between 25 and 50%, even more preferably between 30 and 40%.

The front wall can comprise 3 to 11 bumps, preferably between 5 and 11 bumps, and according to the preferred embodiment 6 to 8 bumps.

The bumps can rise up between 0.5 and 2 mm above the front wall surface, preferably between 0.8 and 1.3 mm.

According to a specific embodiment the mixing device can comprise a dissolution chamber attached to the beverage inlet of the whipper housing. The dissolution chamber and the whipper housing can be moulded in one single piece. The outlet of the dissolution chamber comes out in the whipper housing. Preferably the dissolution chamber comprises at least an inlet for a beverage ingredient and an inlet for a diluent.

Preferably the whipper has a radial front surface with a shape substantially corresponding to the whipper housing front wall surface. The shear gap between the whipper radial front surface and the whipper housing front wall surface is preferably comprised between 0.4 and 1.4 mm.

Particular good results have been obtained for a mixing device such as described hereabove wherein:
the beverage outlet is positioned at the lowest point of the whipper housing front wall surface, and
the whipper housing front wall presents 6 to 8 bumps equally positioned on the front wall surface around the beverage outlet, and
the seven bumps present the same cuboid shape, and
the seven bumps rise up between 0.6 and 1.3 mm above the front wall surface, and
the whipper is a disc presenting six grooves radially extending on its radial front surface, said grooves being equally distanced one from the other,
the surfaces of the grooves are smooth,
the surface of the whipper between the grooves is rough and presents an arithmetic maximum surface roughness (Sz) of at least 400 μm, and an arithmetic mean surface roughness (Sa) of at least 30 μm.

The whipper housing front wall of the mixing device presents a truncated cone shape tapering from a diameter of about 40 mm to about 31 mm and wherein the whipper presents a diameter of about 30 mm. Yet any other smaller or bigger mixing device presenting the same proportional ratio between the different diameters of the front wall truncated cone and the whipper are covered by the present invention.

According to a second aspect, there is provided a whipper for a mixing device, wherein said whipper is disc shaped and presents:
a central hole configured to cooperate with a drive shaft,
a back side surface and a front surface,
   wherein the surface of the radial front surface (32) of the whipper is rough and presents an arithmetic mean surface roughness (Sa) of a at least 40 μm, and
   an arithmetic maximum surface roughness (Sz) of at least 400 μm.

Preferably the radial front surface comprises grooves radially extending on the front surface, said grooves being equally distanced one from the other.

This whipper device can be used in the mixing device described in WO 2013/149942 in order to improve the foaming function of the whipping device, in particular when soluble plant-based milk powder are mixed with a diluent like water for dissolution and foaming. The corresponding beverage machine holding such type of mixing device can be retrofitted with this new impeller.

According to a third aspect, there is provided a beverage preparation machine comprising:
a mixing device such as described above,
a diluent supply, preferably water supply, configured for delivering diluent to the mixing device,
a beverage ingredient container configured for delivering ingredient to the mixing device, preferably through the opened top,
a motor with a drive shaft connected to the whipper through the back wall of the whipper housing.

The machine can comprise a device to restrict the cross section of the beverage outlet downstream the mixing chamber.

The machine can comprise a device for opening or closing the beverage outlet, such as a pinching valve cooperating with a deformable tube attached to the beverage outlet.

According to a fourth aspect, there is provided a method for preparing a beverage with the beverage preparation machine such as described above, said method comprising the steps of
introducing a diluent and a beverage ingredient in the mixing device, and
rotating the whipper,
   wherein the method comprises the steps of:
closing the beverage outlet before the diluent is introduced in the mixing device and keeping the beverage outlet closed during the rotation of the whipper.

Preferably the beverage ingredient is a soluble beverage powder such as milk powder, a plant-based milk powder, a cocoa powder. Other soluble powders like soluble coffee, soluble fruit powder.

Preferably the diluent is water.

According to the preferred method the whipper is rotated at a speed of at least 9000 rpm, preferably at least 10000 rpm.

In an alternative embodiment, the beverage ingredient can be a liquid such a liquid concentrate that requires dilution and foaming or frothing, such a liquid concentrate (milk concentrate or chocolate concentrate or syrup).

In another alternative embodiment, the beverage ingredient can be a liquid that requires foaming or frothing such as milk or plant-based milk.

According to another aspect, the invention concerns the use of a mixing device such as described hereabove for preparing a frothed cocoa beverage or a frothed milk or plant-based milk beverage.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

The characteristics and advantages of the invention will be better understood in relation to the following figures:

FIG. 1 represents a beverage dispenser comprising a mixing device,

FIG. 2 represents a mixing device in which the features of the present invention can be implemented,

FIGS. 3 and 4 are back and perspective views of the whipper housing of the mixing device according to the preferred embodiment of the present invention,

FIGS. 5A and 5B illustrate whippers according to the present invention,

FIG. 6 illustrates a device for opening or closing the beverage outlet,

FIG. 6 illustrates a device to restrict the cross section of the beverage outlet.

### DETAILED DESCRIPTION OF EXEMPLARY EMBODIMENTS

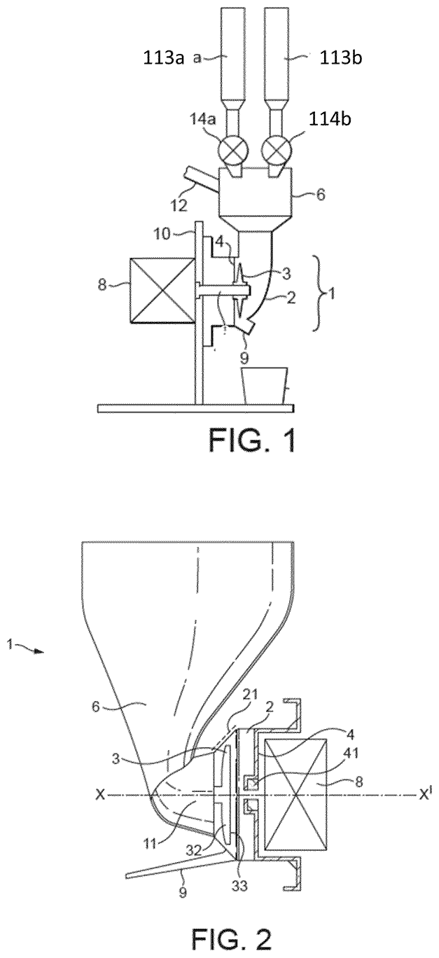

With reference to FIG. 1 the beverage dispenser comprises two food ingredient storing units 113a, 113b connected to respective dosing units 114a, 114b able to provide food ingredient doses to a common dissolution chamber 6. According to another embodiment the beverage dispenser can comprise a single dosing unit connected to the different storing units. The storing units can be a disposable tank like a cartridge, a can or tin, a pouch, . . . or it can be a non disposable canister that is refilled with powder food ingredients.

The food ingredient can be any ingredient that forms a beverage when mixed with a liquid diluent. It can be a soluble powder or a soluble liquid concentrate. According to the invention it is preferably chocolate or milk. When different storing units are present, they preferably contain different food ingredients.

The dosing units comprise means for dosing the food ingredient. This means can be a dosing screw, a dosing auger, perforated discs or a peristaltic pump for a beverage concentrate. The dosing units are placed at the bottom of the storing units to receive the beverage ingredient therefrom by gravity.

The dose of food ingredient issued from a dosing unit 13a, 13b is delivered to the dissolution chamber 6 where it is mixed with a diluent, usually water, introduced from a diluent inlet 12. The mixture is mixed by the mixing device 1 attached to the dissolution chamber comprising a whipper housing 2 and a back wall 4. The assembly of the whipper housing 2 and the back wall 4 forms a chamber in which is lodged a whipper 3 such as an impeller. The whipper is connected to a drive shaft 41 fixed to the frame 10 of the dispenser. The drive shaft is actuated by a motor 8. The whipped beverage leaves the mixing device 1 through an outlet 7 that can be connected to an outlet tube 9 and is delivered in a cup 15.

FIG. 2 is a more detailed view of a mixing device 1 susceptible to be implemented in the dispenser of FIG. 1. The mixing device 1 comprises the whipper housing 2, the whipper 3 and the back wall 4. The whipper housing and the back wall forms a whipper chamber in which is lodged the whipper. The whipper 3 is attached to the drive shaft 81 and the drive shaft is supported by the back wall 4. The drive shaft 81 is actuated by a motor 8. The whipper 4 presents a radial back surface 33 that faces the whipper housing back wall 4 and a radial front surface 32 opposed to the radial back surface. The whipper front surface 32 faces the inlet of the mixing device 11. The whipper housing comprises a front wall 21 (underlined by a dotted line) at the inlet of the mixing device. The front wall presents an opening 22 corresponding to the inlet 11 of the mixing device. The front wall 21 radially tapers from its peripheral edge to the edge of the opening 22; preferably the front wall presents the shape of a truncated cone. The whipper housing comprises a peripheral side wall that extends from the peripheral edge of the front wall and parallel to the axis XX′. The end of the peripheral side wall leans on the back wall 4 to close the mixing chamber. The inlet 11 of the whipper housing is attached to the dissolution chamber 6. The whipper housing and the dissolution chamber can be made of one integral single piece of material.

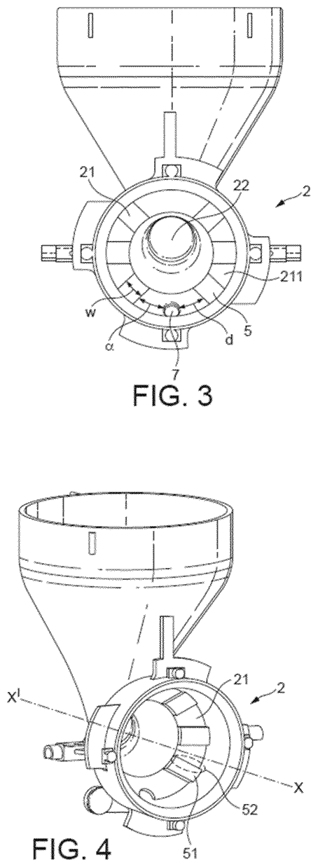

FIGS. 3 and 4 illustrate a whipper housing 2 presenting the preferred features. The front wall 21 presents several bumps 5 elevating from its surface 211. The upper surface of each bump is parallel to the front wall surface so that each bump appears like a local elevation of the front wall surface.

In the illustrated preferred embodiment, the front wall present six bumps. All the bumps present the same shape of a cuboid with a flat top surface 51 and flat side surfaces with sharp edges between said different surfaces. For the best foaming function, the edges of the bumps must not be curved or smooth. All the bumps preferably present the same size. The bumps preferably extend from the whole axial length of the whipper housing front wall surface 211 that is from the opening 22 to the peripheral edge of the front wall. According to the invention no bump is present on the whipper housing peripheral side wall that is parallel to the axis XX′. For each bump, its width is greater than its height. Due to the small height of the bumps above the front wall surface 211 (between 0.5 and 2 mm, preferably between 0.8 and 1.3 mm), the bumps present the shape of rectangular plates elevating from the surface 211 of the whipper housing front wall. The outlet 7 of the whipper housing is positioned at the lowest part of the front wall and the bumps 5 are equally positioned on the front wall surface 211 around the outlet 7. Globally the sum of the surfaces of all the bumps is around 35% of the whipper housing front wall surface. According to the preferred embodiment the two bumps surrounding the beverage outlet must not be directly adjacent to said outlet. Preferably these two bumps are positioned at a distance d of at least 2 mm, preferably at least 5 mm, from the beverage outlet. The outlet 7 of the whipper housing comprises a tube that is slightly oriented downwards to help for the evacuation of the beverage.

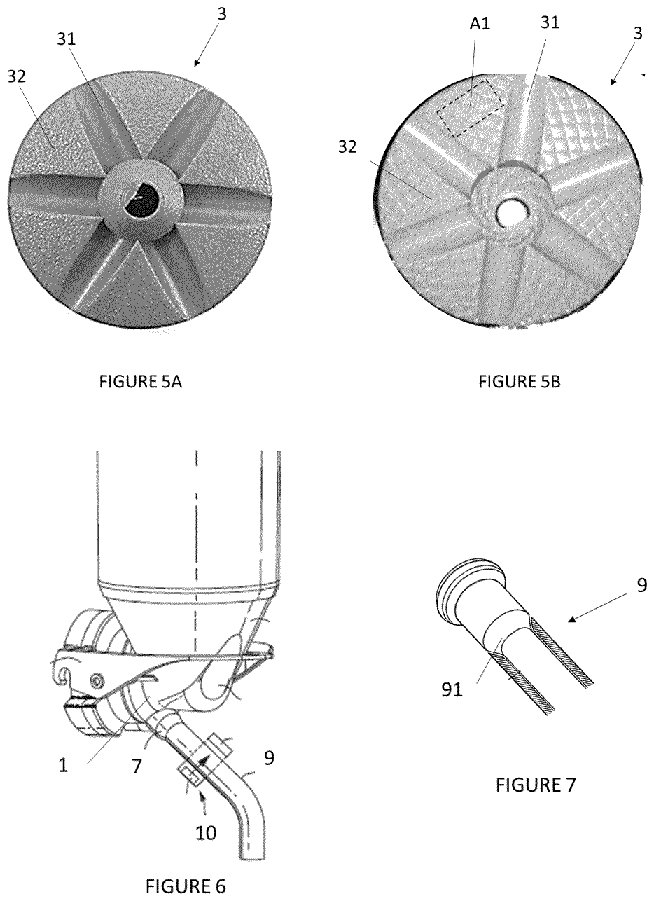

FIGS. 5A and 5B illustrate whippers 3 that are preferably used with the mixing device of the present invention and in particular with the whipper housing of FIGS. 3 and 4. The whipper is a disc presenting a diameter of 31 mm and of which front face 32 comprises six grooves 31. These grooves are equally distanced one from the other. Preferably these grooves extend from the centre of the disc to the periphery of the disc and present a depth comprised between 1 and 2 mm and a width comprised between 2 and 6 mm. The surface of these grooves is smooth.

In the whipper of FIG. 5A, the surface of the radial front surface 32 of the whipper is rough except the surfaces of these grooves are smooth.

In the whipper of FIG. 5B, except the surfaces of these groove, the surface of the radial front surface 32 of the whipper is rough and in addition presents a geometrical pattern (snake skin type).

Both whippers are made of plastic and were produced by injection moulding. A part of the surface of the mould was texturized to provide the final rough surface and, the geometrical pattern, Texturization of the mould was obtained by laser surface texturing. Yet other process can be used like chemical etching.

For both whippers the surface roughness of the radial front surface 32 between two grooves 32 (as illustrated by the surface A1 in FIG. 5B) was analysed with a non-contact roughness meter system Keyence VR5200 3D Profilometer.

The whipper of FIG. 5A showed:
an arithmetic mean surface roughness Sa of 37 μm, and
an arithmetic maximum surface roughness Sz 220 μm.

The whipper of FIG. 5B showed:
an arithmetic mean surface roughness Sa of 85 μm, and
an arithmetic maximum surface roughness Sz 740 μm.

By comparison, a whipper with a smooth surface, that is to say no surface texturizing at all in the mould presented:
an arithmetic mean surface roughness Sa of 24 μm, and
an arithmetic maximum surface roughness Sz 139 μm.

The different whippers were used in the whipper housing of FIGS. 3 and 4 of the beverage dispenser of FIGS. 1 and 2 and cappuccinos were prepared from coffee and frothed rice milk. 30 ml of coffee was produced by extraction of roast and ground coffee in a specific brewing chamber and 130 ml of rice milk was produced from 30 g of soluble rice powder in the mixing device of FIGS. 2, 3, 4 with types of different whippers. Frothed milk was dispensed in a container and then coffee was dispensed in frothed milk. The whipper rotated at a speed of about 10000 rpm.

The height of the rice milk foam above the liquid mixture of coffee and milk was measured in the final drinking cup with the following results:

| | Height of the rice milk foam |
|---|---|
| Whipper of FIG. 5A | 5.42 mm |
| Whipper of FIG. 5B | 9.20 mm |
| Whipper with smooth surface | 4.45 mm |

As schematically illustrated in FIG. 6, the beverage outlet 7 can be connected to an outlet tube 9 and the beverage preparation machine can comprise a closing device 10 for either opening or closing the tube. This closing device can comprise a movable pinching valve 141 lodged in a valve assembly body 142. The pinching valve 141 is made movable to pinch the tube 31, that is a deformable tube. Accordingly, the tube can be pinched and closed or not pinched and opened.

In the process of preparation with this configuration of the machine, the following steps are preferably implemented:
first the beverage outlet 7 is closed.
then diluent and beverage ingredient are introduced in the mixing chamber and the whipper is rotated.

When the beverage is well frothed, the whipper is stopped and the beverage outlet 7 is opened to dispense the beverage.

FIG. 7 illustrates the presence of a restrictor 91 inside the tube 9 attached to the beverage outlet off the mixing device. The restrictor is a mean to restrict the diameter of the outlet tube. In the preferred embodiment, the restrictor can be a tapered portion of the outlet conduit. Tapered portion is configured to restrict the flow of the fluid therethrough, which can reduce the velocity of the flow of the liquid product through output conduit, which, in turn, prolongs the exposure of the fluid to the whipper.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

mixing device 1
beverage inlet 11
diluent inlet 12
whipper housing 2
front wall 21
whipper 3
groove 31
front surface 32
back surface 33
hole 34
back wall 4
bump 5
upper surface 51
edge 52
dissolution chamber 6
beverage outlet 7
motor 8
drive shaft 81
tube 9
restrictor 91
pinching valve 10
storing unit 113a, 113b
dosing unit 114a, 114b

1: A mixing device comprising:
a whipper housing, a whipper and a back wall, the whipper housing and the back wall forming a whipper chamber in which the whipper is lodged, and the whipper housing comprising a beverage inlet and a beverage outlet; and
a drive shaft for driving the whipper, the drive shaft supported by the back wall, and wherein:
the whipper presents a radial back surface facing the back wall of the whipper housing, and the whipper further comprises a radial front surface opposed to the radial back surface,
the whipper housing comprises a front wall, the front wall facing the radial front surface of the whipper, and
wherein the whipper is disc shaped, and
wherein at least a part of the radial front surface of the whipper is rough and presents an arithmetic maximum surface roughness of at least 200 μm.

2: The mixing device according to claim 1, wherein the rough part of the radial front surface of the whipper presents an arithmetic mean surface roughness of at least 30 μm.

3: The mixing device according to claim 1, wherein the rough part of the radial front surface of the whipper presents a pattern engraved on the radial front surface of the whipper.

4: The mixing device according to claim 3, wherein the arithmetic maximum surface roughness relates to the engraved pattern.

5: The mixing device according to claim 1, wherein the radial front surface of the whipper comprises grooves radially extending on the radial front surface.

6: The mixing device according to claim 5, wherein surfaces of the grooves are smooth.

7: The mixing device according to claim 1, wherein the front wall of the whipper housing presents bumps elevating from a surface of the front wall, an upper surface of each of the bumps being flat, and edges of the upper surface being sharp.

8: A whipper for a mixing device, wherein the whipper is disc shaped and comprises:
a central hole configured to cooperate with a drive shaft,
a back side surface and a radial front surface,
wherein the radial front surface of the whipper is rough and presents an arithmetic maximum surface roughness (Sz) of at least least 200 μm.

9: The whipper according to claim 8, wherein the radial front surface comprises grooves radially extending on the radial front surface, the grooves being equally distanced from each other.

10: A beverage preparation machine comprising:
the mixing device according to claim 1,
a diluent supply configured for delivering diluent to the mixing device,
a beverage ingredient container configured for delivering ingredient to the mixing device, and
a motor with a drive shaft connected to the whipper through the back wall of the mixing device.

11: A method for preparing a beverage with the beverage preparation machine according to claim 10, the method comprising:
introducing a diluent and a beverage ingredient in the mixing device,
rotating the whipper, and
closing the beverage outlet before the diluent is introduced in the mixing device and keeping the beverage outlet closed during the rotating of the whipper.

12: The method according to claim 11, wherein the diluent is introduced in the mixing device before the beverage ingredient.

13: The method according to claim 11, wherein the beverage ingredient is milk powder, a plant-based milk powder, or a cocoa powder.

14: The mixing device according to claim 1, wherein the arithmetic maximum surface roughness (Sz) of the rough part of the radial front surface of the whipper is at least 400 μm.

15: The mixing device according to claim 1, wherein the arithmetic mean surface roughness (Sa) of the rough part of the radial front surface of the whipper is at least 40 μm.

16: The mixing device according to claim 1, wherein the pattern engraved on the radial front surface of the whipper is a geometric pattern.

17: The whipper according to claim 7, wherein the arithmetic maximum surface roughness (Sz) of the rough part of the radial front surface of the whipper is at least 400 μm.

18: The beverage preparation machine of claim 10, wherein the diluent supply is a water supply.

19: The beverage preparation machine of claim 10, further comprising a device to restrict the cross section of the beverage outlet downstream the chamber.

20: The beverage preparation machine of claim 10, further comprising a device for opening or closing the beverage outlet.
